(19) United States
(12) Patent Application Publication
(10) Pub. No.: US 2014/0200840 A1
(43) Pub. Date: Jul. 17, 2014

(54) Platform for Portable Sensing Applications

(71) Applicants: Shane COX, Erskineville (AU); Ian MAXWELL, Five Dock (AU)

(72) Inventors: Shane COX, Erskineville (AU); Ian MAXWELL, Five Dock (AU)

(73) Assignee: Instrument Works Pty Ltd, Redfern (AU)

(21) Appl. No.: 14/133,513

(22) Filed: Dec. 18, 2013

(30) Foreign Application Priority Data
Dec. 19, 2012 (AU) 2012905550

(51) Int. Cl. G01D 9/00

(52) U.S. Cl. CPC G01D 9/00
USPC 702/104; 702/188

(57) ABSTRACT

Sensing systems are presented in which one or more sensors are operatively associated with a portable device such as a smartphone or tablet computer. A software application on the portable device provides an interface through which a user can interact with the sensors, e.g. to collect readings or perform calibrations. Preferably the portable device acts as an intermediary to a Cloud service for management and storage of measured data and calibration information. Once transmitted to the Cloud, the data can be accessed from any internet-connected device.

### FIELD OF THE INVENTION

The present invention relates to a sensing system for measuring one or more physical or chemical parameters using one or more sensors that are operatively associated with a portable device. The invention has been developed primarily as a means of collecting water quality parameters such as pH, conductivity, oxidation-reduction potential (ORP), dissolved oxygen (DO), turbidity and temperature where the sensors include a probe or sensor head for immersion in water. However, the principles are applicable to any data collection apparatus that may be connected to a portable device by wired or wireless means.

### RELATED APPLICATIONS

The present application claims priority from Australian Provisional Patent Application No 2012905550, filed on 19 Dec. 2012, the contents of which are incorporated herein by reference.

### BACKGROUND OF THE INVENTION

Any discussion of the prior art throughout this specification should in no way be considered as an admission that such prior art is widely known or forms part of the common general knowledge in the field.

The determination of chemical and physical properties of materials is of interest in the industrial, education and research fields. For example it is desirable for environmental engineers to be able to measure the pH and conductivity of water bodies. Typically, measurements are conducted by users with handheld analytical instruments designed to measure one or two pre-specified parameters. The sensors used to take the measurements are generally connected by cable to the instrument body, usually through a BNC type connector or the like. Electronics within the instrument body are used to amplify, filter and condition the analog signals produced by the sensors, which are then converted into digital form and presented to the user, e.g. on a built-in LCD screen. These handheld devices are generally powered by rechargeable batteries, with provision for a charger to be plugged in to the instrument.

Traditional handheld devices often provide the ability to calibrate a connected sensor, e.g. by placing it in one or more solutions of known value or concentration, to establish a set of calibration values.

Some traditional handheld devices allow users to store a limited number of data values collected from the sensor, which can be subsequently exported to another device such as a computer equipped with appropriate downloading software, e.g. via an RS-232 or USB cable.

Known handheld devices are able to measure a range of physical or chemical parameters including pH, conductivity, oxidation-reduction potential (ORP), temperature, turbidity and dissolved oxygen.

### OBJECT OF THE INVENTION

It is an object of the present invention to overcome or ameliorate at least one of the disadvantages of the prior art, or to provide a useful alternative.

It is an object of the present invention in a preferred form to facilitate data transfer and management when capturing information from sensors, instruments and other handheld analytical devices. This is advantageous compared to the current situation where devices have limited or no connectivity to network or online services, requiring data to be hand-written or transferred to a computer via clumsy wired interfaces.

Another object of the present invention in a preferred form is to negate the need for a specialised device or meter when connecting measurement sensors, by integrating the necessary signal conditioning to allow a sensor to be connected to a range of generic portable devices. This will provide a consistent user experience across a range of sensors, and significantly lower the cost compared to existing sensors which each require a specialised device. When several sensors are needed the ability to interface them with a single portable device has advantages in weight, size, general portability and cost.

Yet another object of the present invention in a preferred form is to allow collection and curation of usage statistics of sensors, including calibration information, to provide additional knowledge to both users and manufacturers regarding sensor condition and likely causes of failure or measurement inaccuracies. By connecting via the Cloud calibration can be automated and checked, reducing the risk of using an out-of-calibration sensor.

Yet another object of the present invention in a preferred form is to allow collection and curation of data maps from multiple users such that, for example, water quality maps can be created for surface water in a given region or country, or around the world. This presents a great commercial opportunity to sell data to interested entities.

### SUMMARY OF THE INVENTION

According to a first aspect of the present invention there is provided a method of calibrating at least one sensor operatively associated by wireless means with at least one portable device and a cloud-based server, said method comprising the steps of:

identifying the at least one sensor by an identification system;
initiating on the at least one portable device or in the cloud-based server a calibration routine for at least one of the at least one sensors;
receiving data from the at least one sensor;
applying a mathematical model to the data to calibrate the at least one sensor; and
storing the calibration data for the at least one sensor in the at least one portable device or in the cloud-based server.

The portable device is preferably a smartphone, a tablet, a PDA, or a notebook computer. Preferably, each of the at least one sensors is adapted to measure at least one parameter selected from the group consisting of pH, conductivity, dissolved oxygen, oxidation reduction potential, turbidity, color, concentration of selected ions, concentration of gases, temperature, liquid flow, gas flow, moisture content, pressure, distance, proximity, sound, acceleration, light intensity, magnetic field, electrical potential, electrical current, and radiation level.

In preferred embodiments the calibration routine is implemented using a software application requiring human intervention. In certain embodiments the human intervention comprises one touch of a button on the at least one portable device or on the at least one sensor or in a cloud-based application. In certain embodiments the human intervention comprises placement of the at least one sensor into one or more calibration media.

The stored calibration data, optionally in comparison with previously stored calibration data, is preferably used to alert a user or a system manager that the at least one sensor is at or near the end of useful life.

Preferably, the cloud-based server provides access to the calibration data.

According to a second aspect of the present invention there is provided a system for measuring at least one parameter, comprising:
at least one sensor adapted to measure data on at least one parameter and wirelessly transmit measured parameter data therefrom;
a portable device adapted to receive measured parameter data from the at least one sensor and to measure one or more items of portable device data;
a cloud connection adapted to allow transmission of measured parameter and portable device data between the portable device and a cloud-based server; and
a software application on the portable device or on a cloud-based server adapted to process the measured parameter data and the portable device data.

The software application is preferably adapted to communicate with two or more sensors contemporaneously and also adapted to process the measured parameter data from the two or more sensors together with the contemporaneously-measured portable device data. Preferably, each of the at least one sensors is adapted to measure at least one parameter selected from the group consisting of pH, conductivity, dissolved oxygen, oxidation reduction potential, turbidity, color, concentration of selected ions, concentration of gases, temperature, liquid flow, gas flow, moisture content, pressure, distance, proximity, sound, acceleration, light intensity, magnetic field, electrical potential, electrical current, and radiation level.

The one or more items of portable device data are preferably selected from the group consisting of the current time, date, operator ID, device ID, geographical position, temperature, altitude, atmospheric pressure, atmospheric humidity, acceleration, attitude, magnetic field, light intensity, sound and proximity.

Preferably, the portable device is a smartphone, a tablet, a PDA, or a notebook computer. In preferred embodiments, each of the at least one sensors is adapted to communicate with the portable device via a local network selected from the group comprising Wi-Fi, NFC, IrDA, Wireless USB, Bluetooth, Z-Wave, ZigBee and Body Area Network.

Preferably, the portable device is adapted to communicate with the cloud-based server via a wireless IP or telephonic network.

In certain embodiments the system further comprises a cloud-based server adapted to allow multiple users to access data stored thereon. In other embodiments the system further comprises a cloud-based server adapted to make selected data readily available on the internet. In yet other embodiments the system further comprising a cloud-based server adapted to allow one or more remote users to control the sensor.

In certain embodiments the software application on the portable device or on a cloud-based server comprises a calibration routine for the at least one sensor, adapted to be performed with a one touch operation. In other embodiments the software application on the portable device or on a cloud-based server comprises a calibration routine for the at least one sensor, adapted to operate without human intervention.

### BRIEF DESCRIPTION OF THE DRAWINGS

Benefits and advantages of the present invention will become apparent to those skilled in the art to which this invention relates from the subsequent description of exemplary embodiments, taken in conjunction with the accompanying drawings, in which:

FIG. 1 shows a block diagram illustrating the components of a measurement sensor according to one embodiment of the invention, and how it may be connected to a portable device;

FIG. 2 shows an example of how measurement sensors and portable devices interact with external services to obtain location information and store data in online (Cloud) services which may be accessed by other connected devices such as PCs;

FIG. 3 shows a flowchart for conducting a one-touch calibration procedure in accordance with one embodiment of the present invention;

FIG. 4 illustrates a user interface that may be used with a portable device according to an embodiment of the present invention;

FIG. 5 illustrates how a user interface can be adapted to conduct calibration of one or more connected sensors; and

FIG. 6 illustrates another embodiment of the invention where a user interface has adapted to the connection of a second sensor for additional measurement readings.

### DETAILED DESCRIPTION

Preferred embodiments of the invention will now be described, by way of example only, with reference to the accompanying drawings.

The present invention discloses a system for connecting measurement sensors to portable devices, to collect parameter data as measured by the sensors and perform calibration through a software application, and then synchronise this information with an online or Cloud service to provide a robust system for the collection and curation of parameter data and the management of these sensors. A portable device for example may be a smartphone such as an iPhone or Samsung Galaxy S or a tablet such as an iPad, Google Nexus or Kindle Fire, or a personal computer device such as a personal digital assistant (PDA), laptop, notebook or Chromebook.

According to a first aspect of the present invention there is provided a system for operatively connecting one or more measurement sensors, to a portable device such as a smartphone, tablet or laptop.

Parameter data that may be expected to be measured by a sensor include, but are not limited to:
pH
Conductivity
Dissolved Oxygen
Oxidation Reduction Potential
Turbidity
Colour
Concentration of selected ions (e.g. via ion selective electrodes)
Concentration of gases (such as carbon monoxide, carbon dioxide, oxygen etc.)
Temperature
Flow (gas or liquid)
Moisture content
Pressure
Distance or proximity
Sound
Acceleration
Light intensity
Electrical potential
Electrical current
Radiation level
Magnetic field

The properties may be measured using sensors that are external to the portable device and connected by wired or wireless means, or sensors incorporated within the portable device. Sensors which are already included with many smart phones for example include microphones, cameras, accelerometers, ambient light meters, and near field proximity or touch sensors.

Some sensors are able to measure only one property, while others may come in a form that allows the measurement of multiple properties, such as 2-in-1, 3-in-1 and 4-in-1 sensors. For example it may be possible to measure ORP, pH and temperature with a single sensor.

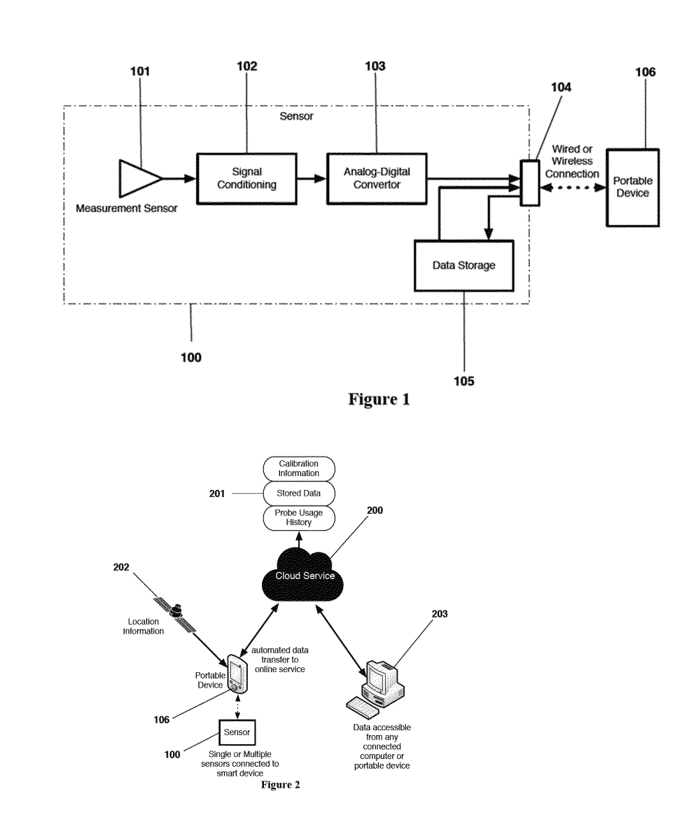

The block diagram provided in FIG. 1 illustrates an example sensor (100) and its connection to a portable device (106). In this embodiment the sensor comprises a sensor head (101), e.g. a pH or conductivity probe, producing an analog signal that undergoes some form of signal conditioning (102) to minimise noise and amplify it if required, then is converted to a digital universal asynchronous receiver/transmitter signal through an analog-digital converter (ADC) (103), before being transmitted to the portable device (106) via wired or wireless means through an interface (104).

In the embodiment shown in FIG. 1 the device also includes data storage (105) which may for example contain information such as a serial number or bar code as part of an identification system for uniquely identifying a sensor, and calibration information.

In certain embodiments the identification system and ADC (103) and data storage (105) are incorporated within a single microcontroller component.

In certain embodiments the sensor (100) is connected directly to the portable device (106) by wired means, without the need for any intermediary component, using the portable device's existing connection capabilities such as a micro-USB plug.

In other embodiments the sensors contain a connector that allows two or more of them to be connected to a portable device in piggy-backed or daisy-chained fashion, e.g. to measure the same property of two or more samples, or different properties of a single sample. In one example embodiment each sensor connector has a male plug for connections towards the portable device and a female plug for connections away from the portable device. We envisage that any number of devices could be piggy-backed in this way, for example to probe a water sample simultaneously for any number of test properties.

In other embodiments the sensor-to-portable device connection is effected by wireless means, e.g. with the addition of a wireless transceiver to the sensor (100), that allows the sensor to connect to a portable device (106) via local network selected from the group comprising Wi-Fi, NFC, IrDA, Wireless USB, Bluetooth, Z-Wave, ZigBee and Body Area Network. or other protocol supported by the portable device. This embodiment would also allow for the connection of multiple sensors to a single portable device, or the connection of one or more sensors to multiple portable devices.

If data is transmitted by wireless means, then the sensor is preferably sufficiently waterproof to allow it to be submersed in water, and the communication protocol is preferably able to transmit the data through water. Similar considerations apply for sensors intended for non-aqueous media.

In certain embodiments a sensor can be set up in place to measure a sample repeatedly over a period of time at predetermined intervals, and the data streamed continuously or periodically to a Cloud server or stored on a portable device for later transmission. A further enhancement of this idea includes monitoring a sample for a specific property, e.g. pH, and sending an alarm to a third party (e.g. a person or monitoring system) via an internet or phone connection if the property drifts beyond a certain range. Alternatively, the sensor may be triggered to measure the property more frequently, or start measuring further properties, and transmit the additional data if required.

In one embodiment the physical sensor apparatus would have an attachment point to allow the sensor to be attached to various accessories such as: an adjustable stand to hold the sensor and allow it to be used without the user holding it; a connector for joining two or more sensors together so that they may be used as a unit; a float to allow the sensor to be positioned in a water body without sinking; or a retractable lanyard for when the sensor needs to be used at an extended distance from a user.

FIG. 2 presents in schematic form several interactions between the above-described sensor system and a number of external services. Consistent with FIG. 1, one or more sensors (100) are connected to a portable device (106), which allows a user to interact with the sensors through one or more software applications.

In one embodiment a suitably equipped portable device enables location determination via GPS (202) or some other location service such as cellphone or Wi-Fi network triangulation. This location information would be attached as metadata to any data collected by the sensor system or portable device application, including any calibration information.

When the system is used to collect data or conduct a calibration of a sensor, the information would be stored by the software application. If the portable device has an active Wi-Fi, internet or phone connection or other communication means, this recorded information could also be automatically, and without user intervention, transmitted to a provided Cloud service on a cloud-based server (200). If an internet or phone connection was not present or available at the time of data collection the information would be subsequently transmitted when a connection was next available. The information (201) collected by the Cloud service could for example include calibration information specific to each individual sensor, data stored on the user's portable device, and a history of usage for individual sensors.

In one embodiment the Cloud service also includes a web accessible interface such that that data can be accessed by any connected PC or other computing device (203), not used for the collection of the data and without necessarily requiring the aforementioned software application. This will provide users or their managers or clients with real-time access to the data without the need for direct access to the device connected to the sensor.

The algorithms that perform the calibration of the sensors containing appropriate mathematical models can exist on the portable device or in a cloud service and data and results can be communicated there between and to the sensors by means described herein. Parameter data and calibration data can be stored for each sensor either in the sensor itself, or on the portable device or in the cloud, and this information can be communicated between these devices as required in an automatic fashion or with user input.

The mathematical models are dependent upon the sensor being calibrated. For example for pH measurement each individual sensor must be continually calibrated using the well-known Nernst equation. As a pH sensor ages its properties changes and an un-calibrated pH sensor will likely give erroneous results. To calibrate a pH sensor two or three solutions of known pH are required and also a specific routine for measuring these solutions with precautions for cross-contamination. Often temperature correction must also be included in the calibration of pH sensors. Previously such calibration has been done ‘locally’ with a sensor attached to a hand-held or desktop device with a display therein and buttons associated with calibration. In the current system the algorithms that are required for calibration are either incorporated into the portable device or reside in a cloud based server.

According to a second aspect of the current invention there is provided a software application on a portable device that provides an interface through which a user can interact with and collect readings from a sensor, and that acts as an intermediary to a Cloud service. The interface may for example comprise a touch screen or a set of hard keys or buttons.

In one embodiment, a software application detects when a sensor is connected to the portable device and automatically adapts the user interface in response to this connection. The interface presentation will generally depend on the number of sensors connected to the device and the parameters that are being measured.

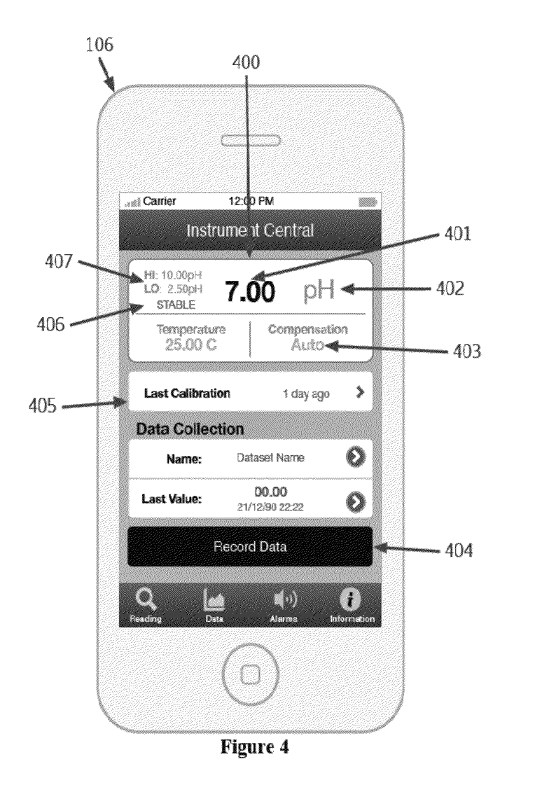

FIG. 4 shows one example embodiment of a user interface comprising a touch screen, where a display (400) of a portable device (106) indicates that a pH sensor is connected, for measuring pH of a solution. The measured value (401) obtained from the sensor is reported directly to the user, and if alternative units can be used to report a parameter value they may be cycled through by the user touching the units field (402). In the present example of pH, which is a temperature-dependent parameter, a temperature compensation field (403) is included in the user interface to allow a user to apply a compensation factor using an automatically measured or manually entered temperature.

In other embodiments the interface enables a user to set high and low level alarms (407) which provide audible or visual feedback if a measured parameter is outside an acceptable range. Furthermore the display can provide visual feedback (406) to a user regarding the stability of the measured parameter. Alarms can also be set to alert third parties via the Cloud, or to start other actions such as additional local measurements or some type of corrective action, e.g. via a SCADA (supervisory control and data acquisition) system integrated into a water plant. These actions would be facilitated by the development of or subscription to some sort of standardised data transfer protocol and format.

If a connected sensor requires calibration, the interface can contain a field (405) indicating the time elapsed since the last calibration for that sensor. In certain embodiments, dependent on the sensor and the parameter being measured, a warning will be presented to a user if the elapsed time has exceeded a predetermined value, to inform them that the sensor needs to be calibrated.

The calibration data and associated mathematical models in the software can include mechanisms to identify the failure of a calibration procedure and then communicate to the user, or to a system manager via the Cloud, that a specific sensor may be at the end of useful life or that a specific measurement may need to be re-executed.

In addition to reporting measured values, the interface can allow a user to record and store individual data points with the touch of a button or field (404). When a datum point is collected the application may automatically append to the collected value a range of metadata to be associated with the value. This metadata may include, but would not be restricted to, the units of the value, a unique identifier for either or both of the sensor and the portable device, time and date information, location co-ordinates where available, calibration information if required for the sensor, type of sample (e.g. surface water), identifier for the user, and user-definable fields such as special categories and comments. Preferably the device will offer a user the ability to add “smart” fields based on other features that can be measured by the portable device, e.g. via GPS or accelerometers, images of the local environment, sound, current time, date, operator ID, device ID, temperature, altitude, atmospheric pressure, atmospheric humidity, attitude, magnetic field, light intensity, and proximity, etc. Furthermore a user can be provided with the ability to add metadata manually, which may include names for each datum point or the associated dataset, and any additional comments.

In an alternative embodiment a user can also specify that data is to be collected at regular intervals.

In another embodiment the software application will recognize when a user is in the vicinity (for example within 100 m) of a location where data has previously been collected and will be able to provide feedback through the user interface to allow the user to return to the exact location where a previous sample had been taken.

In preferred embodiments the display portion (400) of the user interface is able to adapt to the number and types of parameters being measured. For example FIG. 6 shows a parameter field adapted to the situation where two sensors have been connected, to measure both pH and conductivity.

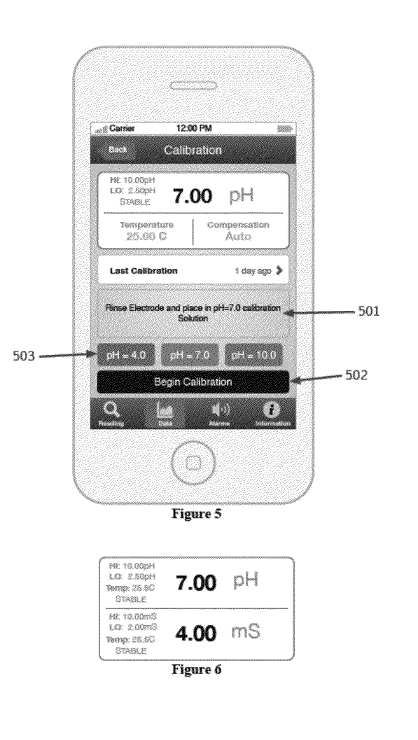

A third aspect of the present invention relates to the calibration of sensors. FIG. 5 shows an embodiment in which a user interface has been modified compared to the interface shown in FIG. 4 to allow a user to conduct a one-touch calibration procedure, described below. This interface allows a user to instigate (502) a one-touch calibration in which the user is provided with instructions (501) on how to conduct the procedure, and with visual feedback.

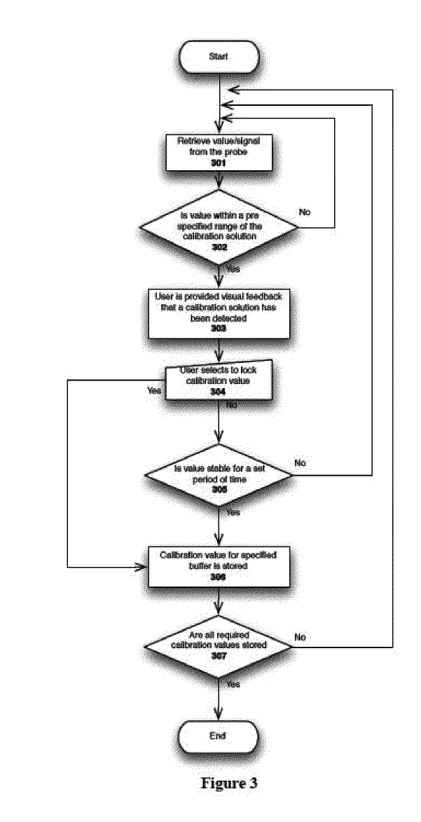

FIG. 3 provides an example flowchart for the one-touch calibration of a sensor, using the interface shown in FIG. 5. A user initially touches a specified field or button (502) to begin the calibration procedure, and is provided with instructions on how to proceed (501). The calibration procedure then retrieves an un-calibrated value from the sensor (301) and determines if it is within a predetermined range of the calibration medium (302). For example with pH this range may be ±lpH unit of the calibration solution value. If the un-calibrated value is not within this range the process repeats until a retrieved value is within the range, at which time visual feedback is provided to the user through the user interface (303). The user may then choose to lock in the present value to the calibration settings (304) by touching the appropriate field or button (503). If the user does not intervene the procedure then determines if the current value is stable (305), where stability is defined by fluctuations being less than a predetermined amount within a specified time period; generally this will depend on both the parameter being measured and the sensor with which it is being measured. If the stability criterion is not met, the procedure repeats from the first step (301) until it has been satisfied, or a predetermined time limit is reached. If the stability criterion is met the current value is stored in the calibration settings. If on the other hand the procedure times out, an indication of failure of the calibration routine is stored.

Where it is required to calibrate a sensor with more than a single point the last step in the calibration procedure is to determine if all of the required variables have been successfully obtained. If not, the procedure repeats until this criterion has been met, at which time the procedure is concluded and the new set of calibration settings are implemented into the software application and used to correct un-calibrated values.

An example of how this procedure would be implemented is described for the calibration of a pH sensor, where one embodiment of the user interface is shown in FIG. 5. In this example the pH sensor requires three calibration solutions which are specified to be pH 4.0, 7.0 and 10.0. The pre-specified calibration solution range is ±1 pH and the stability criterion is fluctuations of <0.05 pH in 5 seconds. When a user touches or clicks the ‘begin calibration’ field or button (502), they are prompted through the user interface to clean the sensor and immerse it in the indicated calibration solution. When the sensor is immersed the signal from the sensor is read by the application and if the value is within 1 pH unit of the specified solution value the corresponding field or button (503) will flash. If the user provides no manual intervention and the value remains within the specified range the field button will continue to flash until the stability criterion is met, or the procedure times out. The field or button will then stop flashing and the calibration value for that solution, or calibration failure, will be recorded. The user is then prompted to remove the sensor from that calibration solution, clean it and immerse it in the next calibration solution. This is repeated until calibration values from each of the three solutions have been recorded. The user will then be informed of the success or failure of their calibration.

In another embodiment of a calibration procedure, a user is provided with a method for identifying the calibration medium they are using directly within the procedure. This may for example be through the application or inclusion of near field communication (NFC) chips, radio-frequency identification (RFID) tags, quick response (QR) codes, or barcodes or serial numbers located on the packaging of the calibration medium which could be read with the portable device's camera and fed automatically into the software application. A function within the procedure would allow the user to scan or enter the details which would then synchronize with the Cloud service, and retrieve information about the medium previously provided by either the manufacturer or another user. For example it may include batch numbers, manufacture dates and the date the medium was first used for calibration. This will give the user feedback on the suitability of their calibration medium.

The Cloud service may also contain mathematical models, e.g. algorithms, to assess calibration data for individual sensors in the field, and send messages to the user via the software application, or via phone or text messages, that a sensor or sensor is nearing the end of its useful life. This benefits the user by ensuring they are always using a sensor within specifications.

In other embodiments the portable device or the cloud-based service instigate sensor calibration automatically, e.g. periodically or before a measurement is taken, with or without subsequent human intervention. As with user-instigated calibration routines, the calibration results, including failure, can be stored on the portable device or on the Cloud service for dissemination or assessment.

A fourth aspect of the present invention relates to the Cloud service and the methods it incorporates for the management and storage of measured data and calibration information.

In one example embodiment the Cloud service allows the data collecting application to transmit the data to the Cloud to be sorted, stored and managed. Once transmitted to the Cloud the data is accessible from any Internet connected device, eliminating any need for user intervention in the transfer of data from the collection device to other devices where the user may wish to access it.

In one embodiment, when accessing their data stored within the Cloud from a web interface, a user will be presented with their data by a number of alternative methods. In one method a numerical view of the data is provided, where the information is presented based on dataset identifier or name. This information may be provided visually as a graph or in a tabular format, and each individual datum point will retain all of the previously described metadata collected during its capture by the software application on the portable device. Alternatively, the data may be presented in a map view, where all or a selection of the individual data points are visually represented on a map.

A further embodiment would allow a user to synchronise data to another device such as a PC or phone automatically. For example data collected on one device, when transmitted to the Cloud service, would be automatically downloaded to linked devices, working in a manner similar to Dropbox for example. The user would also be able to define the format in which the information is downloaded.

When data is presented in a map view, if individual locations contain a number of datapoints, then by selecting the location a graph will show measured values as a function of the time they were recorded.

In another embodiment a user would also be able to select an area within the map, and all data points measured within that area would be available, optionally for storage across a number of individual datasets.

In yet another embodiment, in addition to viewing the data within a Cloud service, users would be provided with a range of predefined functions that would allow them to aggregate and manipulate their data and generate custom graphs or dashboards from which they can monitor results.

In yet other embodiments the provider of a Cloud service, or a client who has bought access to such a product, is able to map measurements geographically and in time. For example a Cloud service provider can construct a regional or global map of surface water quality in real time. Ultimately such a map would have value for the public good as well as commercially. For example search engine enterprises may be interested in buying such data and making it available via their search networks to attract users to their services and hence drive their advertising revenues. This would require users to allow sharing of their data or some subset of their data, and metadata.

A fifth aspect of the invention relates to the Cloud and its use as a management platform for sensors. In one embodiment, and as described above, all calibration information relating to individual sensors is transmitted to the Cloud service when calibration has been conducted. The Cloud service then allows a user to view not only the calibration procedures they have conducted with a particular sensor, but any calibration procedure conducted by any user for that particular sensor. In addition a management platform can store and present manufacturer-supplied information related to each individual sensor, such as the manufacture date, batch number etc, to allow trace back of components if a sensor is observed to be faulty. Furthermore, usage information regarding a sensor can be presented, such as estimated time in use, number of datapoints collected, range of values collected, and first and last usage date. The presentation of this information will allow a user to make more informed decisions about the condition of the sensors they are using and improve their ability to diagnose causes if a sensor fails.

In another embodiment, the data that users have stored within the Cloud, if shared with other users, can be used to provide warnings to other users sampling in the same body of water. For example if a sample of a body of water was previously reported to contain a dangerous contaminant, or contaminants that interfere with a sensor with which the current user is taking a sample, an alert would be presented on the sensor's display.

In another embodiment, sensor management platform data can be utilized by manufacturers as well as by users. For example a manufacturer could aggregate data collected across all sensors and use the information to better inform manufacturing and troubleshooting, and to provide better specifications such as estimated lifetimes of products.

Another embodiment provides the ability for a client or manager to overview various sensors in the field. For example in an education laboratory a lab manager could view a dashboard which aggregates the measurements made by a number of students. In another example a large water company could aggregate water quality measurements made in the field by sub-contractors.

A sixth aspect of the invention relates to the use of sensors and software for specific applications, as opposed to the generic or non-specific data collection described above.

Examples of specific applications include, but are not limited to, consumer applications such water monitoring in swimming pools, spas and aquariums, and soil measurements for gardening.

In an embodiment used for swimming pools, a combination sensor for measuring pH, ORP, conductivity and temperature may be employed, or four separate sensors operatively associated with a single portable device. Additional functionality can be provided within the software application to provide a user with feedback on the relative quality of their water compared to predefined specifications, and provide information on the quantity and type of chemicals required to modify the measured parameters to within desired ranges.

This additional software functionality may be provided as a separate stand-alone app or through an in-app purchase.

In an embodiment used for soil measurements for gardening, a pH and electrical conductivity sensor would be used to penetrate the soil to measure these parameters. Additional functionality provided within the application can allow the user to enter information regarding the soil, such as type, depth and area, and provide feedback on the amount and type of chemicals required to adjust the soil pH to the required value, and similarly for soil moisture. Like with the swimming pool application, the additional functionality could be provided either through a stand-alone app or in-app purchase.

Although the present invention has been described with particular reference to certain preferred embodiments thereof, it should be understood that these have been presented by way of example, not limitation. It will be apparent to the skilled person that variations and modifications can be effected without departing from the spirit and scope of the invention.

We claim:

1. A method of calibrating at least one sensor operatively associated by wireless means with at least one portable device and a cloud-based server, said method comprising the steps of:
identifying the at least one sensor by an identification system;
initiating on the at least one portable device or in the cloud-based server a calibration routine for at least one of the at least one sensors;
receiving data from the at least one sensor;
applying a mathematical model to the data to calibrate the at least one sensor; and
storing the calibration data for the at least one sensor in the at least one portable device or in the cloud-based server.

2. A method according to claim 1, wherein the portable device is a smartphone, a tablet, a PDA, or a notebook computer.

3. A method according to claim 1, wherein each of the at least one sensors is adapted to measure at least one parameter selected from the group consisting of pH, conductivity, dissolved oxygen, oxidation reduction potential, turbidity, color, concentration of selected ions, concentration of gases, temperature, liquid flow, gas flow, moisture content, pressure, distance, proximity, sound, acceleration, light intensity, magnetic field, electrical potential, electrical current, and radiation level.

4. A method according to claim 1, wherein the calibration routine is implemented using a software application requiring human intervention.

5. A method according to claim 4, wherein the human intervention comprises one touch of a button on the at least one portable device or on the at least one sensor or in a cloud-based application.

6. A method according to claim 4, wherein the human intervention comprises placement of the at least one sensor into one or more calibration media.

7. A method according to claim 1, wherein the stored calibration data, optionally in comparison with previously stored calibration data, is used to alert a user or a system manager that the at least one sensor is at or near the end of useful life.

8. A method according to claim 1, wherein the cloud-based server provides access to the calibration data.

9. A system for measuring at least one parameter, comprising:
at least one sensor adapted to measure data on at least one parameter and wirelessly transmit measured parameter data therefrom;
a portable device adapted to receive measured parameter data from the at least one sensor and to measure one or more items of portable device data;
a cloud connection adapted to allow transmission of measured parameter and portable device data between the portable device and a cloud-based server; and
a software application on the portable device or on a cloud-based server adapted to process the measured parameter data and the portable device data.

10. A system according to claim 9, wherein the software application is adapted to communicate with two or more sensors contemporaneously and also adapted to process the measured parameter data from the two or more sensors together with the contemporaneously-measured portable device data.

11. A system according to claim 9, wherein each of the at least one sensors is adapted to measure at least one parameter selected from the group consisting of pH, conductivity, dissolved oxygen, oxidation reduction potential, turbidity, color, concentration of selected ions, concentration of gases, temperature, liquid flow, gas flow, moisture content, pressure, distance, proximity, sound, acceleration, light intensity, magnetic field, electrical potential, electrical current, and radiation level.

12. A system according to claim 9, wherein the one or more items of portable device data are selected from the group consisting of the current time, date, operator ID, device ID, geographical position, temperature, altitude, atmospheric pressure, atmospheric humidity, acceleration, attitude, magnetic field, light intensity, sound and proximity.

13. A system according to claim 9, wherein the portable device is a smartphone, a tablet, a PDA, or a notebook computer.

14. A system according to claim 9, wherein each of the at least one sensors is adapted to communicate with the portable device via a local network selected from the group comprising Wi-Fi, NFC, IrDA, Wireless USB, Bluetooth, Z-Wave, ZigBee and Body Area Network.

15. A system according to claim 9, wherein the portable device is adapted to communicate with the cloud-based server via a wireless IP or telephonic network.

16. A system according to claim 9, further comprising a cloud-based server adapted to allow multiple users to access data stored thereon.

17. A system according claim 9, further comprising a cloud-based server adapted to make selected data readily available on the internet.

18. A system according to claim 9, further comprising a cloud-based server adapted to allow one or more remote users to control the sensor.

19. A system according to claim 9, wherein the software application on the portable device or on a cloud-based server comprises a calibration routine for the at least one sensor, adapted to be performed with a one touch operation.

20. A system according to claim 9, wherein the software application on the portable device or on a cloud-based server comprises a calibration routine for the at least one sensor, adapted to operate without human intervention.
